(19) United States
(12) Patent Application Publication
(10) Pub. No.: US 2006/0263510 A1
(43) Pub. Date: Nov. 23, 2006

(54) Hydroxyl radical modification of carbohydrates

(76) Inventors: Roman Skuratowicz, Hickory Hills, IL (US); Allison Alton Sprague, Prescott (CA)

Correspondence Address: NORRIS MCLAUGHLIN & MARCUS, P.A., P O BOX 1018, SOMERVILLE, NJ, 08876, US

(21) Appl. No.: 11/132,017

(22) Filed: May 18, 2005

(51) Int. Cl. A23G 3/00

(52) U.S. Cl. 426/658

(57) ABSTRACT

A process for modifying carbohydrates by reaction with hydroxyl radicals. The hydroxyl radicals may be formed by the photoreaction of water, peroxide or other hydroxyl suitable chemical or electrochemical breakdown of water, peroxide or other hydroxyl suitable chemical. Also, compositions and products comprising carbohydrates modified by the process.

### BACKGROUND OF THE INVENTION

1. Field of the Invention

The invention pertains to the modification of carbohydrates with hydroxyl radicals. The invention further relates to the carbohydrates modified with the hydroxyl radicals.

2. The Related Art

The modification of carbohydrate can be divided into two main types: chemical and Theological. Chemical modification generally refers to the substitution of carbohydrate with chemical groups and by means of changing the charge condition of the carbohydrate, or increasing the stability. Rheological modifications are generally used, when higher dry matter contents are desirable in a solution, which means decreasing the viscosity by hydrolysis or oxidation. For hydrolysis, enzymes or acids can be used. Oxidation generally involves treating the carbohydrate with bromine, chloride or the corresponding metal hypohalite in an alkaline aqueous medium. For example, the treatment of carbohydrate with hypochlorite, such as sodium hypochlorite. Acid conversion is performed by adding acid to hydrolyze the starch and reduce viscosity.

Regarding starch, for example, oxidation typically involves cleavage of various linkages in the starch molecule. Starch is a glucose polymer, which consists of glucose units linked together by ether bonds at the 1,4 points on the glucose ring to make the linear backbone, with additional branches to the polymer linked at the 1,6 unit on the ring. Oxidation will cleave these ether linkages, reducing molecular weight of the starch molecules. In addition, they can also cleave the glucose ring between the 2, 3 units, and can additionally convert one or both of these resulting aldehyde groups to carboxyls. The choice of oxidant, amount of alkali, temperature and reaction time can cause different rates of thinning as well as vary the amount of carboxyls produced in the thinned starch through the oxidation process. Other selective oxidants, like periodate, will only attack certain bonds on starch, with periodates the 2-3 linkage. Acid modification, or thinning, is conducted at relatively low pH and is a more random cleavage, but can continue on to lower viscosities or convert starch to sugars.

One of the major differences between oxidation and acid conversion is the formation of carboxyl groups by oxidation at points of cleavage on the carbohydrate molecule. Carboxyls affect many properties of the modified carbohydrate; affecting stability, color change and film properties of starch pastes. Different oxidation conditions have produced similar viscosity starch with different carboxyl content thereby resulting in modified carbohydrates with properties different from each other and acid converted carbohydrate.

In the present specification all parts and percentages are on a weight by weight basis unless otherwise specified.

### SUMMARY OF THE INVENTION

The invention pertains to a process for modifying carbohydrates, such as starch, using hydroxyl radical modification. In the process, the hydroxyl radicals react with carbohydrate slurry to form a modified carbohydrate product with reduced viscosity and other properties. The process incorporates techniques such as photoreaction, electrochemical conversion or a similar method to convert peroxide, water or other suitable chemical, for example another hydroxyl containing chemical, to hydroxyl radicals. Carbohydrate, as used in this specification, is intended to have the broadest possible definition and specifically includes starch and other polysaccharides such as hydrocolloid and cellulose, either separately or in combination.

The invention further pertains to carbohydrates that have been modified by the hydroxyl radicals, such as a thinned modified starch having properties different from conventional modified or converted starch. When the modified carbohydrate is added to liquid comprising, at least, water and cooked, a generally clear paste is obtained which develops into an opaque bright white gel as it cools and experiences set back.

### DETAILED DESCRIPTION OF THE INVENTION

The process of the invention concerns modification of carbohydrate, by the reaction with hydroxyl radicals. A hydroxyl radical is an OH radical not containing an extra electron to cause a negative charge. The process comprises the steps of providing a carbohydrate slurry, such as by combining, at least, solvent, for example, water, and carbohydrate to form a slurry, and then modifying the carbohydrate in the slurry by the reaction of the carbohydrate with the hydroxide radicals. The reaction may occur either under acidic or alkali conditions. Acid or alkali may be added to the slurry, to control pH, while the slurry is being formed or after the slurry is established. The use of hydroxyl radicals reduces reaction time and chemicals necessary to modify the carbohydrate and provides a more efficient reaction.

In an embodiment of the invention the hydroxide radical is obtained by the photoreaction of water, peroxide, or other suitable chemical, such as a hydroxyl containing chemical, with ultraviolet light. Examples of peroxides that may be used are hydrogen peroxide, sodium peroxide or combinations thereof. The hydroxide radicals may also be obtained by the electrochemical breakdown of water, peroxide or other suitable chemical, such as a hydroxyl containing chemical.

The hydroxyl radical reaction with the carbohydrate may be accelerated by use of a catalyst, an example of which is titanium dioxide. The reaction may, however, proceed without a catalyst. Gel inhibitors, such as sodium sulfate or sodium chloride, may be added to the slurry prior to, during or after the hydroxyl radical reaction.

In an embodiment of the invention, the carbohydrate used in the process is starch. For example, granular starch, which is uncooked and not gelatinized, may be used. In this embodiment, the process comprises the steps of providing a starch slurry and reacting the starch with hydroxyl radicals, such as those obtained by the photoreaction or electrochemical breakdown of water, peroxide or other suitable chemical with ultraviolet light. The reaction may occur in the presence of alkali, under acidic conditions or under neutral conditions to thin the starch. Cooked starch, such as cooked starch paste, may be modified with the hydroxyl radicals in the process, and can be thinned under alkaline, neutral or acidic conditions.

Starches useful in the invention include natural unmodified starches and starches previously modified by means other than the hydroxyl radical reaction of the invention, such that the carbohydrate used in the process is a “previously modified starch”, for example a chemically modified starch. Carbohydrates also include other polysaccharides like hydrocolloid and cellulose. In addition, carbohydrates include dextrins and maltodextrins, corn syrups and other sugars. Use of carboxymethyl, cationic or other modified carbohydrates is within the scope of the invention.

Starch is a commodity chemical produced from the root, stem or fruit from a number of plants. It is a high molecular weight carbohydrate polymer which is comprised of linear and branched polysaccharide polymers and it can have moisture content from about 8% to about 20%, most commonly from about 11% to about 13%. Starches such as those derived from corn, wheat, barley, tapioca, potato and the like are suitable, as well as sorghum varieties. Blends of starches from various sources also can be used. Pearl starches and powdered starches, granular or uncooked starches, and cooked or pregelled starches may be used. Starches derived from other genetic forms of corn, such as high amylose and waxy corn would also be suitable.

The modified starch which is used in accordance with the invention can be mechanically, chemically or heat modified. Compared to unmodified starches, modified starches frequently possess superior physical properties such as increased solubility, better film forming, increased whiteness, improved gel strength, viscosity stability, increased adhesivity, improved resistance to shear and increased resistance to freeze-thaw degradation. Modified starches or carbohydrates that may be used include, for example, carboxymethyl, acetate, hydroxyethyl, hydroxypropyl, phosphate, crosslinked, octenylsuccinate or cationic starch.

Examples of chemically modified starches which can be used in the invention and are commercially available are SUREBOND® Industrial Corn Starch or STABLEBOND® Industrial Corn Starch. These modified starches have residual carboxyl functionality and extreme uniformity and are available from Corn Products International, Inc., Westchester, Ill., USA (“Corn Products”).

Hemicellulose is an example of a hydrocolloid useful in the invention. Hemicelluloses are described in U.S. Pat. No. 5,358,559 which is incorporated herein in its entirety by reference. Other hydrocolloids that may be used include gum arabic, xanthan gum, gum karaya, tragacanth, sodium alginates, carageenan, Guar gum, Locust bean gum, tara, pectins, gellan, cellulose derivatives such as carboxymethyl, methyl or ethyl cellulose, microcrystalline cellulose, or other polysaccharide type hydrocolloids. Combinations of hydrocolloids may be used.

Cellulose is a straight chain polymer made of repeating units of the monomer glucose. The monomers are linked together through 1,4 glycosidic bonds.

Examples of alkali materials which may be used in the process include alkali metal hydroxides, such as sodium hydroxide, potassium hydroxide or calcium hydroxide. Combinations of caustics may be used. Also, acids may be used in the process to adjust pH. The pH of the slurry may be from about 2 to about 11. When starch is the carbohydrate modified in the process of the invention, the pH is ideally from about 7 to about 11, and may be adjusted using the alkali materials.

The process of the invention requires lower chemical usage than conventional methods for modifying carbohydrate. The process does not involve chlorine based oxidizers, for example hypochlorite oxidation which produces alkyl halides. Also, the process does not involve acids which may introduce potentially corrosive chloride compounds. Thus, the process does not emit alkyl halides, which is a processing benefit for wastewater treatment, and the resulting product will not contain alkyl halides or halogens (i.e. chloride compounds), which expands the utility of the modified carbohydrate from the process of the invention. The modified carbohydrate can be used in applications, such as food, pharmaceuticals and cosmetic applications, where alkyl halides and halogens are undesired. The modified carbohydrates of the invention have broader end use applications than carbohydrates modified by conventional means. Also, carbohydrates can be thinned more efficiently and to higher levels than can be achieved with typical modification methods known in the art, and cooked starch can be thinned in-situ.

Further, in the process of the invention, the degree of modification can be controlled with greater ease than compared to conventional methods. For example, when an ultraviolet source, such as the ultraviolet light, used for the photoreaction of water, peroxide or other suitable chemical is turned off, the reaction stops when the ultraviolet source is shut off, and can be restarted when the ultraviolet source is turned back on. Likewise, when electrochemical means are used, such as an electrolytic cell, the reaction will stop when the means are shut off and will restart when the means are turned back on. With a conventional hypochlorite or acid modification process, it is difficult and time consuming to restart the reaction once it is halted.

The slurry resulting from the process can be dried to form an off-white modified powder comprising modified starch, or other carbohydrate, like cellulose and hydrocolloid. The powder can be re-hydrated and cooked to form a clear paste, particularly when the carbohydrate is corn starch. The paste will become bright white as the paste cools and sets back. The properties of the modified carbohydrates made by the process of the invention are different from that experienced with carbohydrates modified by other means. For example, hypochlorite modified starch is a white powder which pastes cloudy that turns brown with age, and acid thinned starches make off white pastes.

The modified carbohydrate product may be combined with additives to provide functionality or storage stability. Additives include, for example, viscosity stabilizers, functional chemicals and/or crosslinkers. Viscosity stabilizers useful in the invention include surfactants, fatty acid complexes, soaps and agents like monoglycerol stearate. Crosslinkers such as borax, and also insolubilizers like those available from Omnova Solutions, Inc., Fairlawn, Ohio, USA under the tradename SEQUAREZ®, may be used in the invention. Other useful additives include bisulfites, urea, carbonates and the like.

The hydroxyl radical reaction can be combined with one or more derivation reactions, such as cationization, esterification, etherification, phosphorylation, carboxymethylation, crosslinking and the like, to provide modified carbohydrate derivatives from the process of the invention. The derivation reactions can be performed either before or after the carbohydrate is modified.

The modified carbohydrate has a number of uses and may be incorporated into a number of products. For example, pastes made from the modified carbohydrate provide viscosity reduced carbohydrates for corrugating adhesives, paper sizing and paper coatings. The modified carbohydrate, in powder form or in a paste, can be used as a thickener in foods, as well as in other food applications, such as for texturizing, gels, fat replacement, dusting and the like. The modified carbohydrate may be used in pharmaceuticals and cosmetics for gels, pastes and lotions. The whiteness of pastes made from the modified carbohydrate, and lack of alkyl halides and halogens, resulting from the photoreaction or electrochemical conversion process provide the modified carbohydrate product with a greater range of applications than with carbohydrates, such as starch, modified through conventional means. Also, the setback characteristics of the starch, in that upon setback of the starch, a white paste is achieved, makes the modified starch product particularly useful in applications where setback is preferred, such as in gypsum board and baking or confectionary applications.

### EXAMPLES

### Example 1

Two separate pilot trials produced viscosity reduced starch using hydroxyl radicals created from the photoreaction of hydrogen peroxide with ultraviolet radiation. A starch slurry comprising carbohydrate and water, at approximately 30% solids, was passed through a continuous hydroxyl radical reactor (Mobil Cat system from PURIFICS® ES, London, Ontario, Canada) with hydrogen peroxide and sodium hydroxide. Air, oxygen, ozone and titanium dioxide catalyst were also added to the continuous hydroxide radical reactor to determine their effect on thinning and carboxyl formation.

The modified starch products made in the continuous hydroxide radical reactor produced clearer pastes when cooked and bright white gels as compared to hypochlorite oxidized starch having similar fluidity characteristics. Pastes made from the modified starch had a Brookfield viscosity at 20% solids and about 65.5° C. (150° F.) of about 20 to 25 centipoise. Also, the pastes showed acceptable viscosity stability when stored for 30 minutes at 50° C. (122° F.).

### Example 2

Starch, modified by reaction with hydroxyl radicals, is jet cooked at neutral pH, 133.3° C. (290° F.) and about 340 kilopascal (50 psi) backpressure. The paste has acceptable film characteristics when drawn down as a film or on paper, such as in surface size or coating applications.

### Example 3

Lightly thinned hydroxyl radical treated starch is applied to corrugating adhesive as a carrier starch to increase adhesive cooked solids and provide carrier setback to create a tackier, stringier adhesive. The modified starch is cooked in a high shear mixer at about 37.8° C. (100° F.) with sufficient alkali to completely cook starch. Additional water, unmodified starch, and borax are added to complete the corrugating adhesive. The hydroxyl radical treated starch is typically 10-20% of the total starch in the adhesive. Alkali is added to sufficiently lower the gel temperature of the adhesive to below about 65.5° C. (150° F.), and borax is typically added at 50-100% of the dry caustic (in the form of sodium hydroxide) in the adhesive. The gel temperature refers to the uncooked or secondary portion of the adhesive which is suspended in the unmodified starch that acts as a carrier. The exact ingredients and proportions of ingredients in corrugating adhesives vary by plant and desired handling properties.

### Example 4

Hydroxyl radical treated starch is jet cooked at about 137.8° C. (280° F.) and about 207 kilopascal (30 psi) backpressure. The cooked starch is mixed with surfactant (VS100 from Magrabar Chemical Corporation, Morton Grove, Ill., USA) in an amount of about 0.5% by weight the components in the paste. The resulting paste cools to an opaque white gel and has stable viscosity. This paste may be incorporated with preservatives and as an active ingredient for lotion formulations.

We claim:

1. A process for modifying carbohydrate comprising the step of reacting carbohydrate in a slurry with solvent with hydroxyl radicals.

2. The process of claim 1 wherein the solvent is water.

3. The process of claim 1 wherein the hydroxyl radical is formed from the reaction of water, peroxide or other hydroxyl containing chemical with ultraviolet radiation or the electrochemical breakdown of water, peroxide or other hydroxyl containing chemical.

4. The process of claim 1 wherein the carbohydrate is selected from the group consisting of starch, hydrocolloid and cellulose.

5. The process of claim 4 wherein the starch is a previously modified starch.

6. The process of claim 4 wherein the starch is cooked.

7. The process of claim 1 wherein the peroxide is selected from the group consisting of hydrogen peroxide, sodium peroxide and combinations thereof.

8. The process of claim 1 comprising the additional step of adding alkali to the slurry prior to or during the reaction step.

9. The process of claim 8 wherein the alkali is an alkali metal hydroxide.

10. The process of claim 9 wherein the alkali metal hydroxide is selected from the group consisting of sodium hydroxide, potassium hydroxide and combinations thereof.

11. The process of claim 1 comprising the additional step of adding acid to the slurry prior to or during the reaction step.

12. The process of claim 1 comprising the additional step of a derivation reaction.

13. The process of claim 12 wherein the derivation reaction is selected from the group consisting of cationization, esterification, etherification, phosphorylation, carboxymethylation and crosslinking.

14. The process of claim 1 comprising the additional step of using a catalyst during the hydroxyl radical reaction.

15. A modified carbohydrate made by the process of claim 1.

16. A modified carbohydrate derivative made by the process of claim 12.

17. A composition comprising a modified carbohydrate powder which when re-hydrated and heated provides a clear paste that becomes pearl white after setback of the carbohydrate.

18. The composition of claim 17 wherein the carbohydrate is selected from the group consisting of starch, hydrocolloid and cellulose.

19. The composition of claim 17 further comprising additives selected from the group consisting of viscosity stabilizers, functional chemicals, crosslinkers and combinations thereof.

20. A product comprising the modified carbohydrate of claim 15.

21. The product of claim 20 selected from the group consisting of corrugating adhesive, paper sizing, paper coating, gypsum board, food, gel, paste and lotion.
